(19) United States
(12) Patent Application Publication
(10) Pub. No.: US 2022/0070438 A1
(43) Pub. Date: Mar. 3, 2022

(54) CAMERA TESTING DEVICE

(71) Applicant: TRIPLE WIN TECHNOLOGY(SHENZHEN) CO.LTD., Shenzhen (CN)

(72) Inventors: YU-AN CHO, New Taipei (TW); CHIN-JUN WEI, NewTaipei (TW)

(21) Appl. No.: 17/152,056

(22) Filed: Jan. 19, 2021

(30) Foreign Application Priority Data
Sep. 2, 2020 (CN) 202010911332.0

(51) Int. Cl. H04N 17/00; G01M 11/02

(52) U.S. Cl. CPC H04N 17/002; B60R 11/04; G01M 11/0214

(57) ABSTRACT

A camera testing device includes a main body and a third observation window. The main body is used to house a camera module to be tested. The third observation window is arranged on the main body. The third observation window includes an observation port and an observation glass detachably provided in the observation port. A temperature of the observation glass is adjusted to be consistent with a temperature in the main body.

### FIELD

The subject matter herein generally relates to camera testing devices, and more particularly to a camera testing device for testing vehicle-mounted cameras in different conditions.

### BACKGROUND

Generally, vehicle-mounted cameras are designed to operate in a temperature range of −40° C.-105° C. Therefore, it is necessary to test an image quality of a vehicle-mounted camera module at different temperatures. However, in the related art, detection of the image quality of the camera module usually requires many devices to cooperate with each other to measure the image quality of the camera module at different temperatures.

### BRIEF DESCRIPTION OF THE DRAWINGS

Implementations of the present disclosure will now be described, by way of embodiments, with reference to the attached figures.

FIG. 1 is a schematic diagram of a camera testing device according to an embodiment of the present disclosure.

FIG. 2 is similar to FIG. 1, but showing the camera testing device from another angle.

### DETAILED DESCRIPTION

It will be appreciated that for simplicity and clarity of illustration, where appropriate, reference numerals have been repeated among the different figures to indicate corresponding or analogous elements. Additionally, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

The term “comprising” means “including, but not necessarily limited to”; it specifically indicates open-ended inclusion or membership in a so-described combination, group, series, and the like.

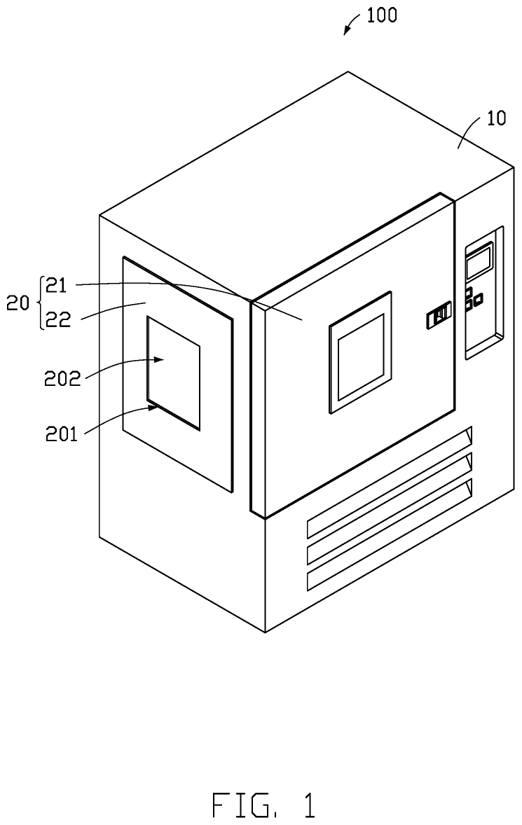

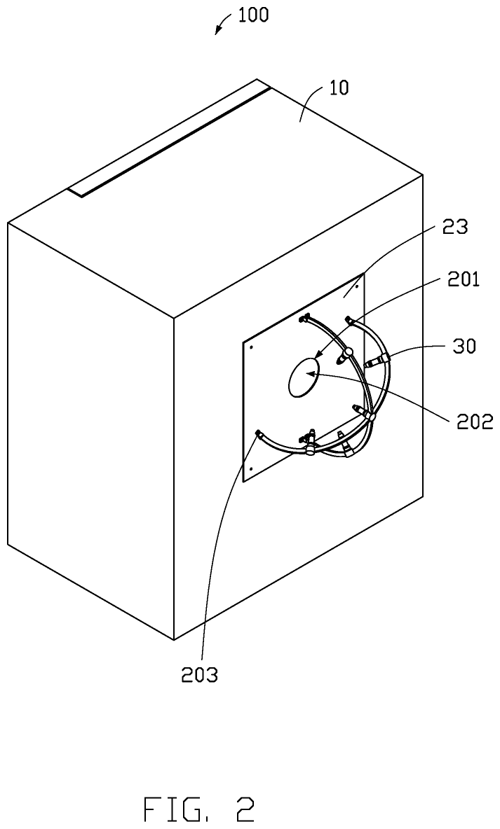

FIGS. 1 and 2 show an embodiment of a camera testing device 100 for performing image quality and reliability tests on camera modules, such as vehicle-mounted camera modules, under different temperature and humidity environments. The reliability tests may include optical performance testing such as module transfer function (MTF) and spatial frequency response (SFR). The camera testing device 100 includes a main body 10, an observation window 20, a mobile platform (not shown), and at least one collimator 30. The main body 10 is used to house a camera module to be tested. The observation window 20 is provided on the main body 10. A temperature of the observation window 20 can be adjusted to adapt to different test environments in the main body 10. The mobile platform is arranged in the main body 10. The mobile platform is used to carry the camera module to be tested and can drive the camera module to move and rotate, thereby assisting in testing. The collimator 30 is arranged on a side of the observation window 20 away from the main body 10. The collimator 30 can generate parallel light beams to assist in testing.

The main body 10 may include an outer box and an inner box arranged in the outer box. A testing and control unit may be installed between the outer box and the inner box.

An inner surface of the inner box and an outer surface of the outer box may be coated with low-reflective paint to avoid a derived refracted light source.

In some embodiments, the inner box and the outer box of the main body 10 are made of stainless steel plates and coated with black low-reflective paint.

In one embodiment, the inner box is made of SUS #304 stainless steel.

In one embodiment, an insulation material is filled in between the outer box and the inner box to ensure that during an internal constant temperature and humidity test, a surface temperature of the outer box is kept below 40° C. when an internal high temperature test is performed.

In one embodiment, a polyurethane foam board with a thickness of 100 mm or more is used for filling in between the outer box and the inner box.

In one embodiment, a temperature and humidity sensor is provided in the inner box to monitor the environment where the camera module is located in real time. The temperature in the inner box is controlled at −60° C.-120° C., and the humidity is controlled at 25%-95% relative humidity (RH).

In one embodiment, a temperature rising and falling speed of a temperature rising mechanism in the inner box is less than 1° C./min.

In one embodiment, fin-type electric heating tubes are used to heat the inner box.

In one embodiment, an internal circulating water system is used for humidification and dehumidification.

The main body 10 is provided with a heating system, a cooling system, a humidification system, and a dehumidification system. Each system runs independently of the other.

Both the inner box and the outer box undergo integral structural reinforcement treatment.

In one embodiment, a double-layer high and low temperature resistant sealing strip is used for sealing between the inner box and the outer box.

In one embodiment, the inner box can accommodate a plurality of camera modules, so as to test multiple camera modules at the same time.

In one embodiment, a size of the outer box size is 1420 mm*900 mm*1586 mm, and a size of the inner box is 700 mm*700 mm*700 mm.

In one embodiment, foot cups and wheels may be provided on a bottom of the outer box, so that the camera testing device 100 can move.

In one embodiment, a handle may be provided on a side of the outer box to facilitate the movement of the camera testing device 100.

In one embodiment, three side walls of the main body 10 are each provided with an observation window 20. The observation windows 20 include a first observation window 21 located on a front side of the camera testing device 100, a second observation window 22 located on a lateral side of the camera testing device 100, and a third observation window 23 located on a back side of the camera testing device 100.

The first observation window 21 facilitates observing a position of the camera module.

The first observation window 21 may include coated glass to prevent reflection. There are heating elements on opposite sides of the first observation window 21 for heating and lighting. In addition, the first observation window 21 may include a shading member (not shown) that can be opened or closed to isolate penetration of light.

The first observation window 21 adopts a double-channel heat insulation and airtight structure.

The second observation window 22 and the third observation window 23 are respectively provided with an observation port 201. An observation glass 202 is provided in the observation port 201.

A temperature of the observation glass 202 in the observation port 201 can be adjusted according to the temperature in the inner box, so that the temperature of the observation glass 202 and the temperature in the inner box remain the same.

The second observation window 22 and the third observation window 23 are also provided with a defogging element (not shown) for defogging or defrosting the observation glass 202 in the observation port 201 during heating or cooling.

In one embodiment, a thin-film electric heating wire is used for defogging.

The observation port 201 can be square-shaped, circular-shaped, or other shapes to suit the inspection of different camera modules.

In one embodiment, the observation port 201 of the second observation window 22 is square-shaped with a side length of 205 mm, and the observation glass 202 is a single-layer high-penetration quartz glass with a thickness of 3 mm. The observation glass 202 of the second observation window 22 is a detachable glass.

In one embodiment, the observation port 201 of the third observation window 23 is circular-shaped with a diameter of 100 mm, and the observation glass 202 is a single-layer high-penetration quartz glass with a thickness of 3 mm. The observation glass 202 of the third observation window 23 is a detachable glass.

In one embodiment, a flatness range of the observation glass 202 of the second observation window 22 and the third observation window 23 is +/−0.05 mm.

In one embodiment, the second observation window 22 and the third observation window 23 may include a shading member (not shown) that can be opened or closed to isolate penetration of light.

In one embodiment, the observation port 201 is located in a middle of the respective side of the inner box.

In one embodiment, the observation glass 202 is installed in the observation port 201 as close as possible to the outer box. In one embodiment, an outer surface of the observation glass 202 is flush with an outer side of the outer box.

In one embodiment, a distance between a power line and a signal line of the camera testing device 100 and the observation port 201 is greater than 300 mm.

The mobile platform is arranged in the inner box and can control the camera module to rotate at different angles, so as to perform tests at different angles.

The observation window 20 is provided with at least one locking point 203. The locking points 203 surround the observation port 201 and are used to fix the at least one collimator 30.

The collimator 30 is used for wide-angle and long-distance measurement.

Due to a large viewing angle of the vehicle-mounted camera module, a field of view (FOV) is above 150°, and the collimator 30 can be used to adjust to the test of the camera module at different angles.

The camera testing device 100 maintains the temperature of the observation glass 202 consistent with the temperature of the inner box, which prevents the problem of light distortion due to temperature differences. The defogging element prevents fogging and frosting on the observation glass 202 to maintain high light penetration when the camera module is tested, which improves the accuracy of the test. The selection of different types of observation ports 201 can meet the needs of different fields of view. The design of the mobile platform and the collimators 30 in the inner box allows the camera module to rotate at different angles to perform various tests.

The embodiments shown and described above are only examples. Even though numerous characteristics and advantages of the present technology have been set forth in the foregoing description, together with details of the structure and function of the present disclosure, the disclosure is illustrative only, and changes may be made in the detail, including in matters of shape, size and arrangement of the parts within the principles of the present disclosure up to, and including, the full extent established by the broad general meaning of the terms used in the claims.

What is claimed is:

1. A camera testing device comprising:
a main body used to house a camera module to be tested; and
a third observation window arranged on the main body, the third observation window comprising an observation port and an observation glass detachably provided in the observation port; wherein:
a temperature of the observation glass is adjusted to be consistent with a temperature in the main body.

2. The camera testing device of claim 1, further comprising at least one collimator, wherein:
the at least one collimator is arranged on an outer side of the third observation window.

3. The camera testing device of claim 2, wherein:
the third observation window is provided with at least one locking point; and
the at least one locking point surrounds the observation port and is used to fix the at least one collimator.

4. The camera testing device of claim 1, wherein:
the third observation window is capable of defogging and defrosting the observation glass.

5. The camera testing device of claim 1, wherein:
the observation glass is a single-layer high-penetration quartz glass.

6. The camera testing device of claim 5, wherein:
a flatness range of the observation glass is +/−0.05 mm.

7. The camera testing device of claim 1, wherein:
the observation port is circular-shaped or square-shaped.

8. The camera testing device of claim 1, wherein:
the observation window is capable of isolating penetration of light.

9. The camera testing device of claim 1, wherein:
an outer surface of the observation glass is flush with an outer surface of the main body.

10. The camera testing device of claim 1, wherein:
an inner surface and an outer surface of the main body are coated with a low-reflective paint.

11. A camera testing device comprising:
a main body used to house a camera module to be tested;
a first observation window arranged on a first side of the main body;
a second observation window arranged on a second side of the main body; and
a third observation window arranged on a third side of the main body; wherein:
each of the second observation window and the third observation window comprises an observation port and an observation glass detachably provided in the observation port; and
a temperature of the observation glass is adjusted to be consistent with a temperature in the main body.

12. The camera testing device of claim 11, further comprising at least one collimator, wherein:
the at least one collimator is arranged on an outer side of the third observation window.

13. The camera testing device of claim 12, wherein:
the third observation window is provided with at least one locking point; and
the at least one locking point surrounds the observation port and is used to fix the at least one collimator.

14. The camera testing device of claim 13, wherein:
the second observation window and the third observation window are capable of defogging and defrosting the observation glass.

15. The camera testing device of claim 14, wherein:
the observation glass is a single-layer high-penetration quartz glass.

16. The camera testing device of claim 15, wherein:
a flatness range of the observation glass is +/−0.05 mm.

17. The camera testing device of claim 16, wherein:
the observation port is circular-shaped or square-shaped.

18. The camera testing device of claim 17, wherein:
the observation window is capable of isolating penetration of light.

19. The camera testing device of claim 18, wherein:
an outer surface of the observation glass is flush with an outer surface of the main body.

20. The camera testing device of claim 19, wherein:
an inner surface and an outer surface of the main body are coated with a low-reflective paint.
